(19) United States
(12) Patent Application Publication
(10) Pub. No.: US 2025/0199976 A1
(43) Pub. Date: Jun. 19, 2025

(54) Universal Data Bus Serializer

(71) Applicant: AyDeeKay LLC dba Indie Semiconductor, Aliso Viejo, CA (US)

(72) Inventors: Rakhel Parida, Edinburgh (GB); Andrew Davidson, Edinburgh (GB); Tibor Antus, Pilisjaszfalu (HU); Peter Halasi, Budapest (HU)

(73) Assignee: AyDeeKay LLC dba Indie Semiconductor, Aliso Viejo, CA (US)

(21) Appl. No.: 18/979,452

(22) Filed: Dec. 12, 2024

Related U.S. Application Data
(60) Provisional application No. 63/610,381, filed on Dec. 14, 2023.

(51) Int. Cl. G06F 13/38; G06F 13/42

(52) U.S. Cl. CPC G06F 13/385; G06F 13/4282

(57) ABSTRACT

Embodiments of an integrated circuit are described. This integrated circuit may include a Universal Data Bus Serializer. Moreover, the Universal Data Bus Serializer may include: an input to receive data for transmission over a data bus of a vehicle; memory storing a plurality of protocol operating instructions, where each protocol operating instruction corresponds to a given operating protocol; a selection unit, coupled to the input and the memory, that chooses one of the plurality of protocol operating instructions based on a given protocol; and a serial data output to couple to the data bus and to output serial data based at least in part on the given protocol.

### CROSS REFERENCE TO RELATED APPLICATIONS

This application claims priority under 35 U.S.C. 119 (e) to U.S. Provisional Application Ser. No. 63/610,381, entitled “Universal Data Bus Serializer,” by Rakhel Parida, et al., filed on Dec. 14, 2023, the contents of both of which are herein incorporated by reference.

### FIELD

The present disclosure relates to techniques for data serialization using a universal data bus serializer.

### BACKGROUND

In order to provide improved safety and more-convenient transportation options, many automotive manufacturers are including additional sensors and/or features in their vehicles. For example, self-driving cars typically include a wide variety of sensors, such as acoustic and/or electromagnetic sensors that monitor the surrounding environment to detect other vehicles, people, animals, or obstacles. Moreover, many vehicles include sensors that monitor the operation of the vehicles (such as parking sensors or seat-adjustment sensors) and, more generally, components that provide features or functionality (such as internal lighting).

Electrically connecting these sensors and components in a vehicle to one or more integrated circuits is often challenging. Notably, the sensors and components in existing vehicles are often at disparate locations. Furthermore, the sensors and components in existing vehicles are often electrically connected to the one or more integrated circuits using separate wiring. However, as the number of sensors and components continues to increase, the wiring is becoming increasingly complicated, expensive and cumbersome to install and maintain.

### SUMMARY

Embodiments of an integrated circuit are described. This integrated circuit includes a Universal Data Bus Serializer. Moreover, the Universal Data Bus Serializer includes: an input to receive data for transmission over a data bus of a vehicle; memory storing a plurality of protocol operating instructions, where each protocol operating instruction corresponds to a given operating protocol; a selection unit, coupled to the input and the memory, that chooses one of the plurality of protocol operating instructions based on a given protocol; and a serial data output to couple to the data bus and to output serial data based at least in part on the given protocol.

Furthermore, the integrated circuit may include an indicator signal input, where the selection unit chooses the given protocol based at least in part on the indicator signal input.

Additionally, the input may receive data from a processor of a module.

In some embodiments, the input may receive a binary input signal.

Note that the selection unit may include a multiplexer.

Moreover, the selection unit may include a modulation processor that modulates data based at least in part on one of the given protocol.

Furthermore, the memory may store an instruction for the selection unit to select the given protocol.

Additionally, the integrated circuit may be included in a vehicle.

Another embodiment provides an electronic device (such as the vehicle or a vehicle module) that includes: a processor that generates data for transmission; a bus connection that couples to a data bus of a vehicle; and the integrated circuit.

Another embodiment provides a system that includes the integrated circuit.

Another embodiment provides a method for communicating modulated data along a serial bus. This method includes at least some of the operations performed by the integrated circuit.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a block diagram illustrating an example of a system that provides a Universal Data Bus Serializer according to some embodiments of the present disclosure.

FIG. 2 is a flow diagram illustrating an example of a method for communicating modulated data along a serial bus according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

Modern vehicles have various modules located throughout the vehicle. Rather than using point-to-point connections between a switch and a single module, these modules may be communicably coupled to each other by way of one or more data buses. The data bus enables the modules to communicate with other modules and/or a control system for the modules. For example, a master controller may be in communication with several modules in order for the master module to provide commands to the other modules. In another example, many modules may be daisy chained along a single bus. Additionally, some vehicles may include more than one data bus. In some examples, when a vehicle includes multiple data buses, the various data buses may operate on different bus communication standards.

Two example data buses are Controller Area Network (CAN) and Local Interconnect Network (LIN). This description will generally discuss both CAN and LIN but is equally applicable to other data buses as well.

The CAN bus is a widely used communication protocol in vehicles for connecting various electronic control units (ECUs), modules, and sensors (as used throughout this disclosure, the term module may mean ECU, module, or sensor, without limitation). It is a high-speed, robust bus system designed for real-time and safety-critical applications. The CAN bus generally operates using a multi-master architecture, allowing multiple modules to transmit data simultaneously.

The CAN bus typically operates at higher baud rates, sometimes ranging from 125kbps to 1 Mbps, depending on the specific application and requirements. This high speed enables fast and reliable communication between different ECUs, modules, and sensors in the vehicle. The CAN bus uses a differential signaling method, where the voltage difference between two wires is used to transmit data. This signaling modes helps in reducing noise and interference, ensuring accurate data transmission. One of the key advantages of the CAN bus is its ability to support complex and time-critical applications.

The LIN bus is a communication protocol commonly used in vehicles for connecting various ECUs, control modules, and sensors. Compared to the CAN bus, LIN is a lower-cost, lower-speed bus system that is primarily designed for non-critical applications such as interior lighting, climate control, and seat control. The LIN bus generally operates using a master-slave architecture, where one module acts as the master and controls the communication with multiple slave modules.

The LIN bus typically operates at a baud rate of 19.2 kbps, which is significantly slower compared to other bus systems like CAN. This lower speed is suitable for less time- critical tasks, allowing for cost-effective implementation of communication between different vehicle components. The LIN bus may use a single wire for communication, which can simplify wiring and reduce the overall complexity of the vehicle's electrical system.

One of the main advantages of the LIN bus is its simplicity and cost-effectiveness. The protocol is relatively easy to implement, making it an attractive option for manufacturers to incorporate in their vehicles. Additionally, the LIN bus allows for easy diagnostics and troubleshooting, as it supports error detection and reporting. This makes it easier to identify and resolve issues in the communication between modules, contributing to efficient maintenance and repair processes.

Each data bus within a vehicle may form a network of interconnected devices. The devices are able to communicate with each other based on a respective protocol of the data bus. The data may be communicated in one direction or bidirectionally between modules. By way of example, a window-control switch module may use a data bus to communicate a signal to window motor module to raise or lower a window. In another example, a turn signal switch modules may use a data bus to communicate a turn signal indication signal to a turn signal light control module. In yet another example, a master module may be able to control several different modules at once. Additionally, the bus may be used to provide vehicle data to a given module. For example, a vehicle's gauge cluster may contain and ECU or module that receives data (such as the vehicle's velocity, engine speed, oil temperature, etc.) from other modules on the bus and displays the data to the driver of the vehicle. Many other examples of ECUs, modules, and sensors communicating by way of a bus are possible as well.

In general, most vehicle buses operate in a serial manner. Serial data is communicated one bit at a time sequentially. When a module operates on or processes data, in some examples, the data may be operated on or processed in a parallel manner. Therefore, it may be desirable to have a circuit within a given module that converts data from parallel to serial for communication on the bus. Furthermore, the protocol by which serial data is communicated is specified by the given protocol (e.g., CAN or LIN) of the bus.

In a typical system, an ECU, module, or sensor will have a dedicated circuit configured to create the data in serial for output on the bus. In some examples, the dedicated circuit may be an integrated circuit configured to receive data and output a serialized form of the data for transmission over the bus. Thus, a module configured to operate on the CAN bus may include a CAN-specific integrated circuit. Similarly, a module configured to operate on the LIN bus may include a LIN-specific integrated circuit. Additionally, in some examples, the bus-specific serializer may be an individual integrated circuit (i.e., microchip) or the bus-specific serializer may be an intellectual property (IP) block of a larger integrated circuit.

In practice, a vehicle module manufacturer may build a given module to support a certain function. However, depending on the end-use application, the module may need to operate on the LIN bus or on the CAN bus. Thus, the vehicle module manufacturer may have to build two different modules, where one is configured to operate on the CAN bus and another is configured to operate on the LIN bus, despite the two modules having similar functionality. As an example, a first vehicle manufacture may use a CAN bus system to control the operation of vehicle windows and a second vehicle manufacture may use a LIN bus system to control the operation of vehicle windows. If a supplier wanted to sell a window-control module to the two vehicle manufacturers, they would have to make CAN version and a LIN version.

Thus, it may be desirable to provide a Universal Data Bus Serializer. The Universal Data Bus Serializer is configured to output serialized data in many different formats, each for a given data bus. For example, a Universal Data Bus Serializer may be configured to selectively output data according to either the CAN bus protocol or LIN bus protocol (or other bus protocol, as needed). This Universal Data Bus Serializer may enable a module manufacture to build a single module that can operate on either the CAN bus or the LIN bus. Thus, rather than having to use a bus-specific circuit, the module manufacturer can manufacture a bus-agnostic design that can be adapted to various types of buses.

The Universal Data Bus Serializer may take the form of an individual integrated circuit (i.e., microchip) or the Universal Data Bus Serializer may be an intellectual property (IP) block of a larger integrated circuit. In some examples, the Universal Data Bus Serializer may be configured to receive an indication signal of the associated type of bus. In response to the indication signal, the Universal Data Bus Serializer may adapt to outputting serialized data according to the protocol specified by the indicator signal.

In some examples, the indicator signal may be an electrically erasable programmable read-only memory (EEPROM) or electronic fuse (eFuse) that a manufacture can use to specify the mode of operation for the Universal Data Bus Serializer before the module is installed in a vehicle. In cases where the indicator signal is provided by an EEPROM or eFuse, the Universal Data Bus Serializer circuit is manufactured to operate according to multiple bus protocols, but the EEPROM data or eFuse locks its functionality to a single bus protocol. The EEPROM or eFuse may be set by the integrated circuit manufacturer, module manufacturer, the vehicle manufacturer, or by another party in the supply chain.

In other examples, the indicator signal may be set based on an instruction or information received by the Universal Data Bus Serializer during a boot up or operation of the module to which the Universal Data Bus Serializer. The instruction or information may be communicated by way of the bus itself. For example, upon power up a module (or the Universal Data Bus Serializer itself) may wait until it receives a signal over the data bus to determine the format of the data bus protocol. In response to receiving a signal over the data bus, the module may have a processor that determines the protocol of operation of the data bus and responsively provides an indicator signal to the Universal Data Bus Serializer. In another example, the module may contain software that includes instructions setting the mode of operation for the Universal Data Bus Serializer. In some examples, when software is loaded onto the module, which software is loaded may determine the bus protocol for the Universal Data Bus Serializer and will include an instruction the Universal Data Bus Serializer (i.e., a given module may have protocol-specific software builds for each bus protocol). In other examples, a computer coupled to the module may be used for module programming. At this programming stage a respective bus protocol may be selected, and the instruction may be communicated to the Universal Data Bus Serializer. Thus, the Universal Data Bus Serializer will operate according to a single protocol while the device is operation, once the Universal Data Bus Serializer receives and instruction indicate the correct mode of operation.

In some examples, the Universal Data Bus Serializer may include a multiplexor (MUX) unit. The MUX is functionally a switch between multiple different data pathways. In some examples, the MUX may have one pathway that corresponds to each of the possible bus modulation schemes with which the Universal Data Bus Serializer is configured to operate. The previously discussed indictor signal may be an input to the MUX. When the MUX receives this input signal the correct pathway for the given bus protocol is selected. In another example, the Universal Data Bus Serializer may include a modulation processor that receives the input signal and serialized the data appropriately for a given bus protocol.

In various examples, vehicle modules may take many different forms. In some examples, a module may contain a bus interface unit. The bus interface unit is configured to couple the module to a data bus. Depending on the application, the data bus may be a CAN bus, LIN bus, or other bus. The data bus is operable to communicate data to the module, from the module, or both to and from the module. The module may also contain a universal serializer. The universal serializer may be that as described previously. Additionally, the module may contain a processor and/or ECU. The processor or ECU may be configured to communicate data to or from other parts of the vehicle by way of the data bus. In some instances, the processor or ECU may also be configured to receive an input from outside the module, for example, from a switch, other input device, or from a different electrical component of a vehicle. The processor or ECU may then communicate data from the input by way of the data bus. In another example, the processor or ECU may be coupled to an output of the module. In some examples, the output may be a display, an audio processor, or other electrical component. The processor or ECU may be configured to receive data by way of the bus and produce data output. The data output may be displayed on a screen of vehicle, played through speakers of a vehicle, or interact with other portions of the vehicle.

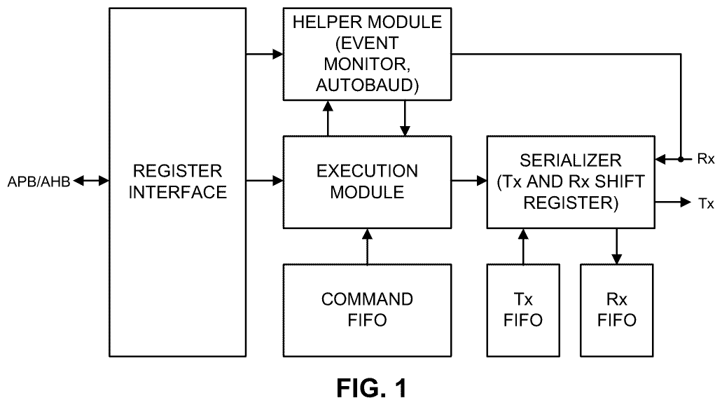

FIG. 1 shows one example system of the present disclosure that provides a Universal Data Bus Serializer. The serializer block is protocol agnostic and can serve any transmission (TX) or reception (RX) operations on a data bus based on the request of the execution module (also known as a command interpreter). Additionally, the register interface may be coupled to a processor via an internal bus (such as ahb/apb of FIG. 1). The internal bus may be used to communicate data to and from a processor.

For example, the processor may communicate data to the Universal Data Bus Serializer by way of the ahb/apb internal data bus for transmission via the TX on the data bus. Similarly, the Universal Data Bus Serializer may receive a transmission via the RX on the data bus including data that ultimately will be communicated to the processor by way of the ahb/apb internal data bus.

The execution module is also a generic module, but it is configured to execute commands that implement various protocols. The execution module may modulate data as required for the given protocol of the data bus. During the operation of FIG. 1, a command may be received from a processor. The command coming from the processor via the ahb/apb internal data bus and pushed into a First In First Out (FIFO) buffer. From the FIFO, the execution module may read the command.

When the Execution Module reads the command, it may balance the timing differences in the signals as the Execution Module dictates the timing required by the protocol of the data bus. Also, during the operation of the Universal Data Bus Serializer, the serializer module of FIG. 1 pops and pushes the payload from/to the RX/TX FIFO on demand and without any external interaction needed.

FIG. 1 may include fewer or additional components, two or more components may be combined into a single component, a single component may be implemented using two or more separate components, and/or a position of one or more components may be changed.

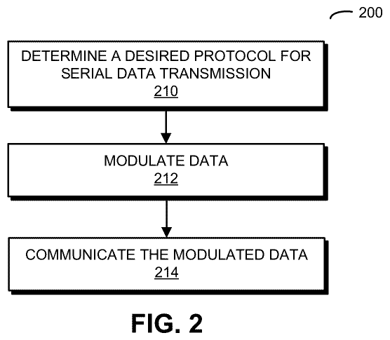

We now describe embodiments of a method. FIG. 2 presents a flow diagram illustrating an example of a method 200 for communicating modulated data along a serial bus using an integrated circuit. During operation, the integrated circuit may determine a desired protocol for serial data transmission (operation 210) from a plurality of protocols. Then, the integrated circuit may modulate data (operation 212) to form the modulated data based on the determined protocol. Next, the integrated circuit may communicate the modulated data (operation 214) along a serial bus.

In some embodiments of the method 200, there may be additional or fewer operations. Moreover, the order of the operations may be changed, and/or two or more operations may be combined into a single operation.

The disclosed integrated circuit and the circuit techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the integrated circuit, in alternative embodiments different components and/or subsystems may be present in the integrated circuit. Thus, the embodiments of the integrated circuit may include fewer components, additional components, different components, two or more components may be combined into a single component, a single component may be separated into two or more components, one or more positions of one or more components may be changed, and/or there may be different types of components.

Moreover, the circuits and components in the embodiments of the integrated circuit may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an integrated circuit may implement some or all of the functionality of the circuit techniques. This integrated circuit may include hardware and/or software mechanisms that are used for implementing functionality associated with the circuit techniques.

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the circuit techniques may be implemented using program instructions that are executed by a processor or in firmware in an integrated circuit.

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An integrated circuit, wherein the integrated circuit comprises a Universal Data Bus Serializer, and the Universal Data Bus Serializer comprises:
an input configured to receive data for transmission over a data bus of a vehicle;
memory storing a plurality of protocol operating instructions, wherein each protocol operating instruction corresponds to a given operating protocol;
a selection unit, coupled to the input and the memory, configured to choose one of the plurality of protocol operating instructions based on a given protocol; and
a serial data output configured to couple to the data bus and output serial data based at least in part on the given protocol.

2. The integrated circuit of claim 1, further comprising an indicator signal input, wherein the selection unit is configured to choose the given protocol based at least in part on the indicator signal input.

3. The integrated circuit of claim 1, wherein the input is configured to receive data from a processor of a module.

4. The integrated circuit of claim 1, wherein the input is configured to receive a binary input signal.

5. The integrated circuit of claim 1, wherein the selection unit comprises a multiplexer.

6. The integrated circuit of claim 1, wherein the selection unit comprises a modulation processor configured to modulate data based at least in part on one of the given protocol.

7. The integrated circuit of claim 1, wherein the memory is configured to store an instruction for the selection unit to select the given protocol.

8. The integrated circuit of claim 1, wherein the integrated circuit is included in a vehicle.

9. A method for communicating modulated data along a serial bus, comprising:
by an integrated circuit:
determining a desired protocol for serial data transmission from a plurality of protocols;
modulating data to form the modulated data based on the determined protocol; and
communicating the modulated data along a serial bus.

10. The method of claim 9, wherein the method comprises receiving an indictor signal; and
wherein the determining is based at least in part on the received indicator signal.

11. The method of claim 9, wherein the method comprises receiving data for transmission; and
wherein the modulating data to form the modulated data comprises modulating the received data.

12. The method of claim 9, wherein the method comprises selecting, using a multiplexer, a data pathway based at least in part on the desired protocol.

13. The method of claim 9, wherein the method comprises reading an indictor signal from a memory; and
wherein the determining is based at least in part on the indicator signal.

14. A vehicle module, comprising:
a processor configured to generate data for transmission;
a bus connection configured to couple to a data bus of a vehicle; and
an integrated circuit comprising a Universal Data Bus Serializer, wherein the Universal Data Bus Serializer comprises:
an input configured to receive input data from the processor;
memory storing a plurality of protocol operating instructions, wherein each protocol operating instruction corresponds to a given operating protocol;
a selection unit, coupled to the input and the memory, configured to choose one of the plurality of protocol operating instructions based at least in part on a given protocol; and
a serial data output configured to couple to the bus connection, wherein the Universal Data Bus Serializer is configured to output serial data from the serial data output by modulating the input data based at least in part on the given protocol.

15. The vehicle module of claim 14, wherein the integrated circuit further comprises an indicator signal input; and
wherein the selection unit is configured to choose the given protocol based at least in part on an indicator signal received via the indicator signal input.

16. The vehicle module of claim 14, wherein the processor is configured to generate the indicator signal.

17. The vehicle module of claim 16, wherein the vehicle module comprises bus-detection circuitry coupled to the bus connection; and wherein the bus-detection circuitry is configured to determine a protocol of the bus and communicate a bus indication signal to the indicator signal input.

18. The vehicle module of claim 14, wherein the selection unit comprises a multiplexer.

19. The vehicle module of claim 14, wherein the selection unit comprises a modulation processor configured to modulate data based at least in part on the given protocol.

20. The vehicle module of claim 14, wherein the memory is configured to store an instruction for the selection unit to select the given protocol.
